(19) United States
(12) Patent Application Publication
(10) Pub. No.: US 2017/0092144 A1
(43) Pub. Date: Mar. 30, 2017

(54) RATING MULTIMEDIA CONTENT

(71) Applicant: Brian WERNHAM, London (GB)

(72) Inventor: Brian WERNHAM, London (GB)

(21) Appl. No.: 15/253,612

(22) Filed: Aug. 31, 2016

(30) Foreign Application Priority Data
Sep. 24, 2015 (GB) 1516923.8

(51) Int. Cl. G09B 7/00; G09B 5/12

(52) U.S. Cl. CPC G09B 7/00; G09B 5/12

(57) ABSTRACT

In one example of rating multimedia content, an apparatus comprises an interface arranged to provide, to a group of one or more users, access to a stored multimedia resource comprising a collection of multimedia content items and to acquire rating information associated therewith. The apparatus comprises a rating module arranged to generate and store rating data indicative of the rating information of at least some of the multimedia content items. The multimedia content items are accessed by users of a group of users through an interface. The apparatus comprises a determination module arranged to determine a subset of the collection of multimedia content items on the basis of at least the rating data.

### CROSS-REFERENCE TO RELATED APPLICATIONS

This application claims the benefit of UK Patent Application No. GB 1516923.8, filed Sep. 24, 2015, which is incorporated by reference herein in its entirety.

### FIELD

The present disclosure relates to online education and particularly, but not exclusively, it relates to delivery of online educational materials.

### BACKGROUND

Massive Online Open Courses (MOOCs) are online courses providing educational materials, lecture courses and assessments to large audiences through the Internet. MOOCs may provide additional interactive elements to supplement an online course such as forums and social platforms via which participants may interact with course organizers. Existing MOOCs fall into two categories. Those that largely follow a traditional university-style lecture course and those that use non-traditional or more collaborative elements to produce course content. When implementing a MOOC, providers face a number of challenges. A challenge for providers of MOOCs following a traditional university-style format is to provide, through a centralized service, content which the course participants will find engaging and relevant, without a high level of collaboration and feedback from course participants. At the other extreme, MOOCs constructed only from participants' own input suffer from a lack of quality control with respect to the course content.

### SUMMARY

An apparatus is provided. The apparatus includes an interface arranged to provide, to a group of one or more users, access to a stored multimedia resource comprising a collection of multimedia content items and to acquire rating information associated therewith. The apparatus includes a rating module arranged to generate and store rating data indicative of the rating information of at least some of the multimedia content items. The apparatus includes a determination module arranged to determine on the basis of at least the rating data a subset of the collection of multimedia content items.

In some embodiments, the rating information comprises at least one of user generated information, or computer-generated information, relating to the multimedia content items, or, for an accessed multimedia content item, a rating value selected from a set of two or more rating values by a user who has accessed the item, or an indication of the number of users who have accessed a content item.

In some embodiments, the rating module is arranged to determine, for a respective multimedia content item, a ratio of the number of users who have accessed the item to the total number of users in the group.

In some embodiments, the determination module is arranged to compare, for the respective multimedia content item, the determined ratio to a threshold ratio. In some embodiments, the determination module is arranged to include multimedia content items having a respective determined ratio that is below the respective threshold ratio in the subset of the collection of multimedia content items. In some embodiments, at least one multimedia content item of the collection is interactive.

In some embodiments, the rating module is arranged to determine, for a respective interactive multimedia content item, a ratio of a number of users who have interacted with the respective interactive multimedia content item to a total number of users in the group.

In some embodiments, the determination module is arranged to compare, for each interactive multimedia content item, the determined ratio to a threshold ratio. In some embodiments, the determination module is arranged to include interactive multimedia content items having a respective ratio that is below the respective threshold ratio in the subset of the collection of multimedia content items.

In some embodiments, the multimedia resource comprises one or more multimedia content items relating to an educational resource. In some embodiments, the one or more multimedia content items comprise questions relating to the educational resource and an interaction with interactive multimedia content comprises a user submitting solutions to the questions.

In some embodiments, the rating module is arranged to generate rating data according to at least one of: a first determined ratio based on a number of positive user ratings of a respective question and a number of attempts of the respective question, a second determined ratio based on a correlation between a proportion of users who answered the respective question correctly and an overall performance of users, or a third determined ratio based on a proportion of users who answered the respective question incorrectly.

In some embodiments, the determination module is arranged to compare, for a first question and a second question, one or more of the first determined ratio, the second determined ratio, and the third determined ratio, and, based on the result of the comparison, determine that one of the first question or the second question is in the subset. In some embodiments, the determination module is arranged to replace the collection of multimedia content items with the subset of multimedia content items to form a new collection of multimedia content items.

In some embodiments, the interface is arranged to receive proposals for multimedia content items from a second group of one or more users. In some embodiments, the determination module is arranged to determine the subset on the basis of additional rating information from the second group of one or more users.

A method is provided. The method includes accessing a multimedia resource comprising a collection of multimedia content items, acquiring rating information associated to the one or more multimedia content items from one or more users, generating and storing rating data indicative of the rating information of at least some of the multimedia content items, and determining a subset of the collection of multimedia content items on the basis of at least the rating data.

In some embodiments, the rating information comprises at least one of: user generated information, or computer-generated information relating to the multimedia content items, or, for an accessed multimedia content item, a rating value selected from a set of two or more rating values by a user who has accessed the multimedia content item, or an indication of the number of user who have accessed the multimedia content item.

In some embodiments, the method comprises comparing, for a respective multimedia content item, the determined ratio to a threshold ratio. In some embodiments, the method comprises including, in the subset of the collection of multimedia content items, multimedia content items having a respective ratio that is below the respective threshold ratio. In some embodiments, at least one multimedia content item of the collection is interactive.

In some embodiments, the method comprises determining, for a respective interactive multimedia content item, a ratio of the number of users who have interacted with the item to a total number of users in the group. In some embodiments, the method comprises comparing, for each interactive multimedia content item, the determined ratio to a threshold ratio. In some embodiments, the method comprises including in the subset of the collection of multimedia content items interactive multimedia content items having a respective ratio that is below the respective threshold ratio. In some embodiments, the multimedia resource comprises one or more multimedia content items relating to an educational resource. In some embodiments, the one or more multimedia content items comprise questions relating to the educational resource and wherein an interaction with interactive multimedia content comprises a user submitting solutions to the questions.

In some embodiments, the rating data is generated according to at least one of a first determined ratio based on a number of positive user ratings of a respective question and the a of attempts of the respective question, a second determined ratio based on a correlation between a proportion of users who answered the respective question correctly and an overall performance of users, and a third determined ratio based on a proportion of users who answered the respective question incorrectly.

In some embodiments, the method comprises comparing, for a first question and a second question, one or more of the first determined ratio, the second determined ratio and the third determined ratio, and, based on the result of the comparison, determining that one of the first question or the second question is in the subset. In some embodiments, the method comprises replacing the collection of multimedia content items with the subset of multimedia content items to form a new collection of multimedia content items. In some embodiments, the method comprises receiving proposals for multimedia content items from a second group of one or more users. In some embodiments, the method comprises determining the subset on the basis of additional user rating information from the second group of one or more users.

A non-transitory computer-readable storage medium storing instructions is provided. The instructions, when executed by one or more processors, cause the one or more processors to access a multimedia resource comprising a collection of multimedia content items, acquire rating information associated to the one or more multimedia content items from one or more users, generate and store rating data indicative of the rating information of at least some of the multimedia content items, and determine a subset of the collection of multimedia content items on the basis of at least the rating data.

### BRIEF DESCRIPTION OF THE DRAWINGS

Various features and advantages of embodiments will be apparent from the detailed description which follows, taken in conjunction with the accompanying figures, wherein:

FIG. 1 is a schematic block diagram of a system for determining a subset of multimedia content items from multimedia resources, according to some exemplary embodiments;

FIG. 2 is a schematic block diagram of a user interface for providing rating information for multimedia content, according to some exemplary embodiments;

FIG. 3 is a schematic block diagram of a system for updating multimedia content based on a determined subset of multimedia content items from a multimedia resource, according to some exemplary embodiments;

FIG. 4 is a schematic block diagram of a system for allowing a group of users to provide additional multimedia content items and rating information, according to some exemplary embodiments;

FIG. 5 is a flow diagram of a method for determining a subset of multimedia content items from a multimedia resource, according to some exemplary embodiments;

FIG. 6 is a flow diagram of a method of determining a subset of multimedia content items based on a threshold ratio, according to some exemplary embodiments;

FIG. 7 is a flow diagram of a method of determining a subset of interactive multimedia content items based on a threshold ratio, according to some exemplary embodiments;

FIG. 8 is a flow diagram of a method of updating a collection of multimedia content items with a determined subset of multimedia content items, according to some exemplary embodiments;

FIG. 9 is a flow diagram of a method of determining one or more ratios and generating rating data, according to some exemplary embodiments; and

FIG. 10 is a schematic block diagram of a computer system, according to some exemplary embodiments.

### DETAILED DESCRIPTION

In the following description, for purposes of explanation, numerous specific details of certain examples are set forth. Reference in the specification to “an example”, “exemplary” or similar language means that a particular feature, structure, or characteristic described in connection with the example is included in at least that one example, but not necessarily in other examples.

Massive Online Open Courses (MOOCs) provide means for distributing educational resources to a larger and more diverse audience than traditional university-style lecture courses can. MOOCs have allowed non-traditional methods of learning to become available through the World Wide Web, such as collaborative teaching with a more participant-focused approach than traditional lecture courses.

According to one approach, a MOOC may be created through a solely collaborative process where course participants suggest ideas to form a course. This may range from a group of participants informally sharing material related to a subject on a forum to companies providing platforms from which registered users can propose topics and ideas to form course content. Alternatively, there are MOOCs which are managed by a centralized authority responsible for building and maintaining associated course content. Typically, MOOCs following this second approach will be maintained with little or no input or collaboration between the participants of the course.

A problem for MOOCs that follow the first approach is a lack of quality control. Without a centralized authority maintaining course content, problems can arise such as course content becoming outdated, participants accidentally deleting content, or participants adding simply irrelevant content to the subject matter of the course. Moreover, without quality control the popularity of a course can diminish over time. For MOOCs that are constructed and maintained following the second approach, participants may feel there is a lack of user interaction and collaboration. This may be due to the course being overly prescriptive or even biased, in terms of course content, for example. The course may include topics which a majority of participants feel is irrelevant or simply not be engaging enough for participants to follow the course. The course may contain information that does not reflect the latest research, or information that was current at the time of the course conception, but that has become outdated. Moreover, nowadays, participants may be disinclined to pursue a MOOC in which the course does not allow them to provide feedback on the quality.

It has been appreciated that a successful approach to addressing these problems is to provide users with a system for constructing a course based on an evolutionary approach to developing course content and assessments. Certain methods and systems described herein follow an approach that allows users to collaborate to include or remove from an educational resource content, and, more generally, any kind of multimedia resource provided by a third-party. The action of including or removing content may be based on rating information. The rating information may be user-generated information, or computer-generated information derived from user behavior, in relation to the content of the multimedia resource. In particular, it is possible to use certain methods and systems described herein to construct, for example, an examination for an educational resource, such as that provided through a MOOC, in a purely collaborative fashion without suffering from the shortcomings of the first approach identified above. However, the present approach does not require a centralized authority to construct and maintain the teaching and assessment resources. In another example, a first and a second group of users may provide and maintain a multimedia resource, with a first group providing rating information for content provided by a second group, without any centralized authority providing content.

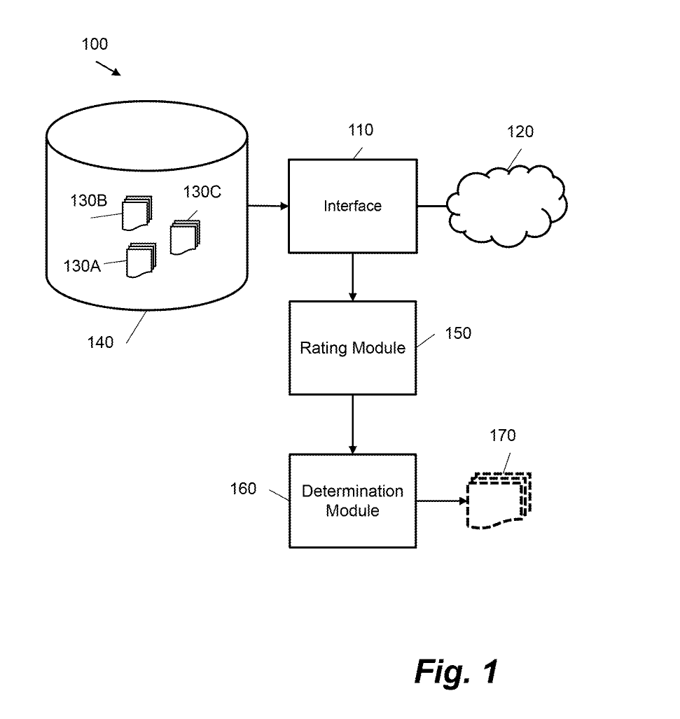

FIG. 1 is a simplified schematic diagram of an apparatus 100 for determining a subset of a collection of multimedia content items according to an example. The apparatus 100 comprises an interface 110 arranged to provide, to a group of users 120, access to stored multimedia content items 130A, 130B and 130C forming multimedia resources which may be stored locally, or may be references to the locations of open multimedia resources that are stored by other providers, for example, by cloud-based providers. Users typically access and/or interact with the content using a computing device (not shown) such as, for example, a personal computer, tablet or smartphone device. In FIG. 1, interface 110 is coupled to a database 140 storing the multimedia content items 130A, 130B and 130C. The interface 110 may be, for example, a network interface in the case where group of users 120 are accessing content through a network such as the Internet or a local area network. If the interface 110 is a network interface it provides the necessary networking functionality for the group of users 120 to access textual and/or audio-visual (AV) content within the multimedia content items through a network. In this instance, the group of users 120 may be executing their own software locally from the point at which they access the network. In another example, the interface 110 is a graphical user interface running in (and accessible from), for example, the so-called cloud. In this instance, users may be provided with direct access to the multimedia resources in database 140 via the interface 110 from the point at which they access the network. For example, in the case that the group of users 120 are accessing the content through the Internet, the interface 110 may be an online interface such as a portal for accessing content. According to another example, the interface 110 may be an application interface residing on a user's local desktop where, for example, users are accessing content items through a network.

The interface 110 is arranged to acquire rating information associated with the group of users 120 accessing the stored multimedia resource in database 140. Rating information may comprise information provided either directly or indirectly from the group of users 120. In one case, rating information may be derived from one or more user inputs received at interface 110. Alternatively, rating information may be information created by the group of users 120 accessing content through the interface 110. While FIG. 1 shows a single database 140 storing the multimedia content items 130A, 130B and 130C, the multimedia resources may be distributed across multiple storage units or, in another example, be shared between groups of users in a decentralized peer-to-peer fashion. Any other appropriate form or configuration of distributed storage could be used.

FIG. 1 shows interface 110 coupled to a rating module 150. According to an example, rating module 150 is arranged to generate and store rating data indicative of the rating information. The rating data is generated to provide a representation of the rating information provided through interface 110. In one case, the rating data is a stored, computer-representation of information received at interface 110. Rating module 150 is coupled to a determination module 160. The determination module 160 is arranged to determine, on the basis of at least the rating data, a subset 170 of the collection of multimedia content items 130.

Determination module 160 is shown outputting a determined subset (in this case, item 170, which may be any one or more of 130A, 130B and 130C) of the multimedia content items. The subset may comprise the actual determined multimedia content items or a reference to or a record thereof. The determination module 160 determines the subset on the basis of rating data generated at the rating module 150. In one example, the group of users 120 accessing multimedia content items 130A, 130B and 130C may provide rating information in the form of an “approval” or “disapproval” of each item. In one example, each user in the group of users 120 may have one or more associated attributes. The attributes may quantitatively reflect that a user has a particular strength (or weakness) in their ability to provide rating information. The rating information provided by a user may be scaled appropriately in accordance with their attributes. In this case, rating module 150 may generate scaled rating data on the basis of the rating information. Determination module 160 may then determine a subset of content items 130A, 130B and 130C based on the scaled rating information. For example, subset 170 may comprise only multimedia content item 130C in the case where the content item 130C received the most approvals from the group of users 120.

According to an example, the group of users 120 may be members of a “social network” in which the users may form connections with other users in the group of users 120. In one case, the number of connections a user forms may also be used to scale the rating information provided by the user. In this case, the rating information from a user may be adjusted appropriately to reflect the user's popularity or social status amongst the group of users 120.

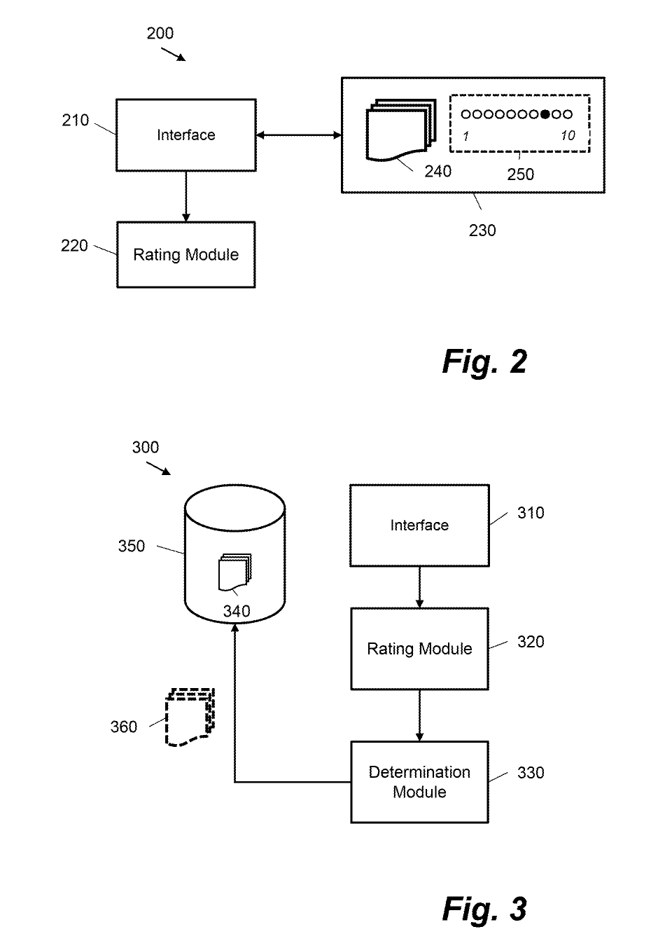

FIG. 2 is a schematic diagram, according to an example, of an interface 210 coupled to a rating module 220, which are, respectively, similar to interface 110 and rating module 150 shown in FIG. 1. In FIG. 2, the interface 210 is arranged to provide a group of users who are accessing multimedia content items, such as users 120 shown in FIG. 1, with a graphical user interface 230 for providing rating information through the interface 210. In this example, users of a group of users are accessing a multimedia content item 240. In FIG. 2, acquired rating information is user-generated information. More particularly, in the example shown in FIG. 2, a user accessing multimedia content item 240 is presented with a screen 250 on graphical user interface 230 and a range of values between a first and second value (in the case of FIG. 2, values between 1 and 10). The user is given the option to input a rating value based on their preference and in response to accessing the multimedia content item 240. The interface 210 acquires rating information provided by the user in the form of the rating value. As with the previous embodiment, rating module 220 is arranged to generate rating data indicative of the respective received rating information. For example, the rating data generated by rating module 220 may be a mean or average of the rating values selected by a group of users for each multimedia content item accessed. In such a case, a determination module (not shown in FIG. 2), such as determination module 160, receives the rating data from rating module 220 for each multimedia content item accessed. The determination module 160 then makes a determination of a subset (not shown), comprising items to keep in the multimedia resource, on the basis of the rating data for each item. In one case, the determination module 160 ranks the items from those with the highest rating data in the event that the rating data comprises a single value, such as an average user rating. The determination module 160 may then determine a subset of multimedia content items to keep in the multimedia resource. For example, the most popular 50% of multimedia content items may be retained. For any items which have not been rated at all or by a sufficient number of users, the rating data may be set to a default value. For example, the items which had not been rated by a predetermined percentage or number of users can be given a maximal rating value such that the determination module 160 determines to keep those items in the subset, automatically. It is anticipated that keeping items that do not have a sufficient number of ratings may motivate users, who may not have rated such items highly had they rated them at all, to provide a low rating at a next rating opportunity. In this way, such items would at some stage be removed, given sufficient low ratings.

In an alternative embodiment, the rating module may generate rating data on the basis of computer-generated rating information. An interface such as interface 110 shown in FIG. 1 may generate rating information as a result of users of a group of users 120 accessing multimedia content items 130A, 130B and 130C. An example of information that may be derived from accesses to the interface 110 is the number of users in the group of users 120 who have accessed one or more content items 130A, 130B and 130C. A rating module such as rating module 150 may be arranged to determine, for a respective multimedia content item, a ratio of the number of users who have accessed the content item to the total number of users in the group. The rating data may then comprise, for each multimedia content item, a ratio of the number of respective accesses to the number of users in the group 120. According to one example, a determination module, such as determination module 150 shown in FIG. 1, is arranged to determine a subset of the multimedia content items on the basis of a comparison of that ratio to a threshold value. For example, the determination module 150 may be arranged to determine that those items which have a ratio below a value of, say, 50% (corresponding to fewer than half of the total group of users accessing the content), should be kept in the subset of content items, because of there being insufficient rating information.

According to some embodiments, the multimedia content items may be interactive. In the present context, the meaning of “interactive” in relation to a multimedia content item is that the item has one or more features or elements which, when accessed through an interface such as interface 110 in FIG. 1, allow the user to interact with those features. For example, a user may be prompted by an interactive element in a multimedia content item to input text, speak into a microphone, draw an image or select a region in an image, perform a gesture or upload and/or download items via the interface. According to some embodiments, a multimedia content item may comprise a plurality of separate interactive elements, such that one or more user actions may be performed in conjunction with any of the other user actions. An “interactive multimedia content item” may therefore be understood as a multimedia content item with at least one interactive element. A user is said to have “interacted” with an interactive multimedia content item when the user has interacted appropriately with the interactive elements in the item (rather than just viewing the item).

An example of a typical interactive item can be described as follows. A multimedia content item may include a first display screen comprising a number of textual and/or audio-visual elements, which can be displayed on a user terminal, and a second display screen with an interactive element, wherein the interactive element allows a user to select items on the screen. This could be, for example, a point-and-click selection where the user chooses an option from a number of options on the basis of having seen an element displayed on the first display screen. Alternatively, the second display screen may prompt a user to perform any one of the actions identified above. In one example of a multimedia content item, the first screen may present a question and the second screen may provide options for a user to select (or enter) a chosen answer. Instead, the question and respective answer inputting means (via the interactive element) may be presented on a single display screen.

In relation to interactive multimedia content items, an apparatus such as apparatus 100 shown in FIG. 1 may also be used to determine a subset of interactive multimedia content items according to user or computer generated rating data. In the example shown in FIG. 1, rating information may be determined to be the number of users out of the group of users 120 who have interacted with an interactive multimedia content item. In this example, rating module 150 may be arranged to determine, for a respective interactive multimedia content item, a ratio of the number of users who have interacted with the item to the total number of users in the group. The determination module 160 may then be arranged to compare, for each interactive multimedia content item, the determined ratio to a threshold ratio. The determination module 160 may be further arranged to include, in a resulting determined subset of multimedia content items, those interactive multimedia content items having a respective ratio below the respective threshold ratio. In particular, this means that an interactive multimedia content item with which only a limited number of users have interacted, as determined by the threshold ratio, will automatically be included in the determined subset of multimedia content items, irrespective of any additional user rating data that has been generated by the rating module. In relation to previously described embodiments, if, for example, 60% of users have accessed an interactive multimedia content item but only 30% of users have then interacted with the interactive element of that item, and the threshold ratio for interacting with the item is 50% of the users in the group of users, the item will automatically be retained in the determined subset of content items.

FIG. 3 is a simplified schematic diagram according to an example of an apparatus 300 for updating, according to a determined subset, a stored multimedia resource comprising one or more multimedia content items. In FIG. 3, are shown an interface 310, a rating module 320, a determination module 330 and a multimedia resource 340, which is stored in a database 350. According to an example, determination module 330 is arranged to determine a subset of multimedia content items based on rating data received from rating module 320. This rating data may be data derived from rating information provided through interface 310 as a result of users of a group of users accessing and/or interacting with the multimedia content items. In the example shown in FIG. 3, determination module generates determination data 360 and sends the determination data 360 to the stored multimedia resource 340 in database 350. In FIG. 3, the determination data may comprise an indication of which multimedia content items are to be kept (or at least made available to users) in the multimedia resource 340 in database 350. In one example, the determination data may be a single vector of bits, each bit representing one multimedia content item, specifying whether to retain or delete the item for each item in the multimedia resource. In further examples, the determination data may comprise additional data specifying how the multimedia content items are to be stored. For example, in a case where users of a first group of users have already accessed items and users of a second group of users are still yet to access those items, the determination module may indicate to the database that those items should be available to the second group but not the first group. In yet further examples, the determination module may indicate in the determination data that an item is to be removed after a certain time period associated with the item has expired or a date has passed. For example, an item which hasn't been accessed by any user by a certain date, or an item which hasn't been accessed at all may be removed.

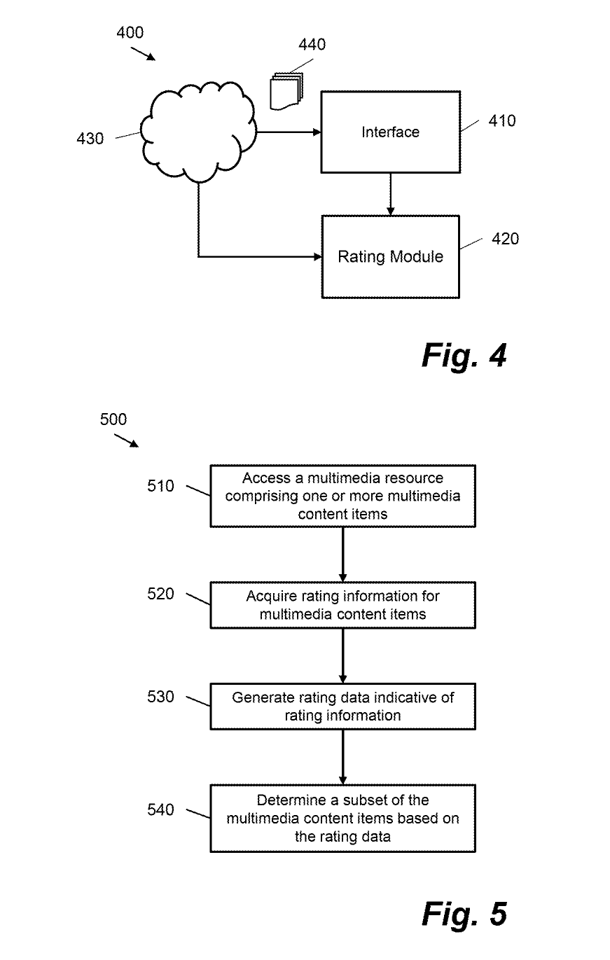

FIG. 4 is a schematic diagram of an apparatus 400, comprising an interface 410 and a rating module 420, which may be accessed by users of a group of users 430. In FIG. 4, the users 430 are presented with an interface 410 through which the may submit proposals for adding multimedia content items 440. The apparatus 400 shown in FIG. 4 may be used in conjunction with and/or in addition to the apparatus shown in FIGS. 1 to 3. In particular, the proposals for multimedia content items 440 may be in addition to those stored in a multimedia resource such as the multimedia content items 130 that are stored in database 140 shown in FIG. 1. When used in conjunction with the apparatus shown in FIG. 1, the group of users 430 may provide proposals for new multimedia content on the basis of content seen by a first group of users such as users 120 shown in FIG. 1, who have accessed stored multimedia content items 130A, 130B and 130C and have provided rating information. In one example, the users 430 see the result of a determination of multimedia content items, such as the determined subset 170 shown in FIG. 1, and propose new content items 440, which may be edited versions of the original content items or, alternatively, new content items altogether. In yet further examples, the proposed content items 440 may comprise a compilation of one or more of the content items 130. In FIG. 4, the group of users 430 are shown to be in communication with interface 410, which is connected to the rating module 420. This provides a mechanism by which the group of users 430 can provide their own rating information to the rating module 420. When used in conjunction with the apparatus 100 shown in FIG. 1, the group of users 430 can provide rating information in addition to that provided by a first group of users, such as users 120. In this way, the second group of users provides a means for providing multimedia content items and determining a subset of content items to retain in addition to those already being stored and accessed by the first group of users. According to an example the second group of users may have the same or at least an overlapping user membership as the first group or it may comprise a subset or superset of the first group of users. In one example, the second group may be a ‘trusted’ subset of the first group. A trusted status may be imbued on a user, for example, based on their qualifications, experience, age, time as a member of the group, the number of past ratings they have delivered that are close to the average, and/or on any other objecting assessment of a user's ability to provide a positive contribution in the sense of developing a high quality multimedia resource comprising high quality multimedia content items.

According to an example, the multimedia resource may comprise content items relating to an educational resource. In the present context an “educational resource” may comprise any material relating to a topic or collection of topics where the material is stored and accessed by a group of users for the activities of learning and/or educating. Examples of multimedia content items for this purpose may comprise one or more of a syllabus outlining an educational course, course content, course objectives and learning outcomes, course assignments, examination questions and examination materials, lecture content and lecture series, videos and web-based content including course web pages, wiki pages, discussion forums, bulletin boards and social networking platforms. In the present disclosure, “interactive multimedia content items” relating to an educational resource may mean any of the previously listed multimedia content items with interactive elements. For example, a question requiring a user to submit a solution in response to the question is one such interactive content item where an interface such as interface 110 in FIG. 1 would provide the means for the user to submit the solution. A second example of an interactive multimedia content item in this context may be a web-based debate where a user is required to engage in a debate via a video link or forum in which the user is prompted by the interface at a given time to submit their response to the debate. In another example, an interactive content item may be an item requiring user-led learning in which the user is prompted via the interface to organize materials relating to the course into their own course syllabus. These are illustrative examples providing an indication of the kind of multimedia content items which may relate to an educational resource in the context of the present disclosure.

Some embodiments may be used to generate an examination for the purpose of assessing a group of users accessing an educational resource. In relation to FIG. 1, multimedia content items may comprise one or more examination questions relating to an educational resource. In this case, the examination questions are electronically stored questions that may have been received from a third-party or alternatively, submitted by the group of users such as users 430 shown in FIG. 4 being stored in a database. In relation to FIG. 1 the group of users 120 access the questions through the interface 110 and provide rating information on the questions via the interface 110. As in previous examples, the rating information can comprise user-generated or computer-generated statistics. According to an example, group of users 120 may provide a rating of an examination question, for example, based on their preference for that question to be included in an examination, as described in relation to FIG. 2. In this case, a user may have a preference for a question which is particularly relevant to the educational resource over a question which they deem to be of less relevance. In one embodiment, the examination questions may comprise one or more of a text, audio or video component. Moreover examination questions may be multiple-choice or require longer text-based answers. The examination questions may relate to two or more parts of an educational resource and need not be limited to a single topic in a course. Examination questions may comprise of a ‘stem question text’ and a marking scheme. In the case of the multiple choice format, the marking scheme may comprise one or more answers which are indicated as incorrect, and one or more distractor answers which are indicated as correct. In addition, each answer, whether correct or incorrect, may have associated ‘feedback’ text which explains why that answer was correct or incorrect. In the case of longer text-based answers, a marking scheme may consist of a number of factors for an examiner to consider in awarding marks. Users may have the ability to review questions that have been authored by other users, and ‘like’/‘dislike’ those questions, and also have the ability to create copies of those questions and improve them. Additional functionality may include the ability to translate questions in to other languages, for example. Users may indicate liking and carry out improvements on any part of a question, correct answer(s), incorrect answer(s), feedback for each answer or, in the case of questions requiring a long text-based answer, could like/dislike or improve the marking scheme by adding, changing or deleting factors for an examiner to consider in awarding marks. Once the users have provided rating information a rating module such as rating module 150 shown in FIG. 1 is arranged to generate and store rating data indicative of the rating information. In this case rating data may include question performance statistics and the preferences of users to include particular questions in an examination out of the set of questions stored in database 140. A determination module such as determination module 160 shown in FIG. 1, can determine the subset of questions for which users had a preference and would then instruct the database to remove those questions from the database which did form part of the subset. It will be appreciated that the process can be iterated multiple times to refine the content contained in the database until, for example, a fixed time has elapsed or until the group of users collectively decide to end the process. In this way an examination relating to an educational resource can be constructed from an initial set of questions, where the content of the examination reflects a group of users' preferences for those questions.

According to another example a user may interact with a question as described in relation to interactive multimedia content items. In one such case, a user may be prompted to provide an answer to a question, such as selecting a solution to a question out of a number of solutions in the case of a multiple choice question. Further types of interaction are possible between a user and interface in relation to questions for an examination. For example, a user may be prompted to enter text as a solution to a question. Embodiments of the apparatus 100 shown in FIG. 1 provide an apparatus for determining a subset of questions to which users have attempted to provide solutions.

In addition to rating data generated according to rating information such as how many users have attempted a question, further rating data may be generated, for example, in the case of examination questions relating to an educational resource. In one case a rating module such as rating module 150 is arranged to generate data according to a determined ratio based on the number of positive user ratings of a respective question and the number of attempts of the question by users in the group. In a second case, the rating module 150 is arranged to generate data according to a determined ratio based on the correlation between the proportion of users who correctly answer the question and the overall performance of each participant. In this case, the correlation is representative of the difficulty of the question in relation to the other questions. In a third case the rating module 150 is arranged to generate data according to a determined ratio based on the proportion of users who answered the question incorrectly. It is possible to generate data depending on combination of these determined quantities depending on the preference of the group of users 120. In particular, rating data based on user ratings such as in the first described case relies on a subjective input from the users attempting the question whereas data generated in the second and third cases is computer-generated statistical data derived from user performance. In the instantiation described herein, determination module 160 is arranged to determine, on the basis of at least the rating data, a subset of the collection of questions. According to an example determination module 160 is further arranged to compare, for a first question and a second question, one or more of the determined ratios and based on the comparison, determine that one of the first and second questions is in the final subset of questions.

An example will now be described in relation to FIGS. 1 and 4, where interactive multimedia content items comprise examination questions relating to an educational resource. In one case, group of users 430 shown in FIG. 4 may be “examiners” proposing questions to a second group of “students” such as users 120 shown in FIG. 1. In this case, the examiners propose examination questions 440 to users 120 who provide solutions to the questions and user-generated rating data via an interface 410. The examiner's 430 may be able to provide additional rating data, which may be, for example, an indication that a subset of questions should deliberately not be included in a final determined subset of questions. Apparatus 400 in this case provides means for students to provide feedback, which contributes to the final structure of an examination, which in turn may be reused on a third group of students. Furthermore, in this example the first group may be a subset of the second group where the apparatus 400 effectively provides a means of self-assessment in an autonomous fashion between groups of users such as users 120.

FIG. 5 shows a method 500, according to an example, of determining a subset of a set of multimedia content items based on rating data. This method may also be applied with the apparatus shown in FIG. 1, in particular, through the interface 110 shown in FIG. 1. At block 510 a multimedia resource comprising one or more multimedia content items is accessed. The multimedia resource and content items may be stored in a database such as database 140 and accessed through an interface such as interface 110 by a group of users 120 as shown in FIG. 1. At block 520 rating information is acquired for each of the multimedia content items. Rating information may be acquired directly from a group of users accessing the multimedia content items or indirectly via an interface such as interface 110 shown in FIG. 1. In method 500 shown in FIG. 5, rating information can be user-generated or computer-generated information. The information may be acquired from a user accessing a multimedia content item and providing a rating value from a set of two or more rating values. For example, as shown in FIG. 2, the method of acquiring rating information can be by a user selecting a value from a set of values on a screen provided by an interface 210. In another case, additional rating information can be supplied by a second group of users, such as users 430 shown in apparatus 400 of FIG. 4. At block 530 rating data indicative of rating information is generated. Rating data may be generated by a rating module such as the rating modules shown in FIGS. 1 to 4. Rating data may be generated as a result of information supplied directly to an entity generating the data. Alternatively the rating data may be generated from latent information which has been measured or acquired indirectly, for example, as a result of a user accessing a multimedia content item. At block 540 a determination of a subset of the multimedia content items is made, based on the rating data, e.g. by the determination module 140 shown in FIG. 1.

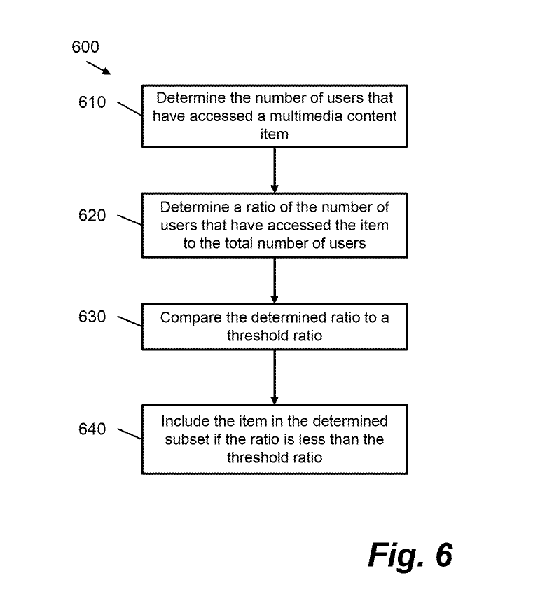

FIG. 6 shows a method 600, according to an example, of determining to include a multimedia content item in the determined subset based on a comparison of a determined ratio to a threshold ratio. The method 600 shown in FIG. 6 may be used in conjunction with the apparatus shown in FIGS. 1 to 4 and the method shown in FIG. 5 to keep multimedia content items in the determined subset which have not yet been accessed by a sufficient proportion of users in a group of users accessing the multimedia resource. At block 610 the number of users who have accessed a multimedia content item in a multimedia resource is determined. In an example of the method 600 being used in conjunction with the apparatus 100 shown in FIG. 1, this determination can be made by the interface which is arranged to acquire rating information. In this case the rating information is itself an indication of the number of users who have accessed the multimedia content item. In another example, a user may provide information indicating that they have accessed an item. At block 620, a ratio of the number of users that have accessed the item to the total number of users in a group of users accessing the multimedia resource is determined by, for example, rating module 150 in FIG. 1. At block 630 the determined ratio from the previous step is compared to a threshold ratio. This threshold ratio may be a user-defined value or a pre-set value determined by a third-party. Alternatively, the threshold may be a variable threshold which is adjusted depending on user preferences. According to one example of method 600, this step may be performed by a determination module such as that shown in FIG. 1. At block 640, a multimedia content item is included in the determined subset if the determined ratio is found to be below the threshold ratio. This step ensures that only the multimedia content items in the resource which have been accessed by a significant proportion of users can be left out of the determined subset. This step may be implemented by determination module 160 shown in FIG. 1.

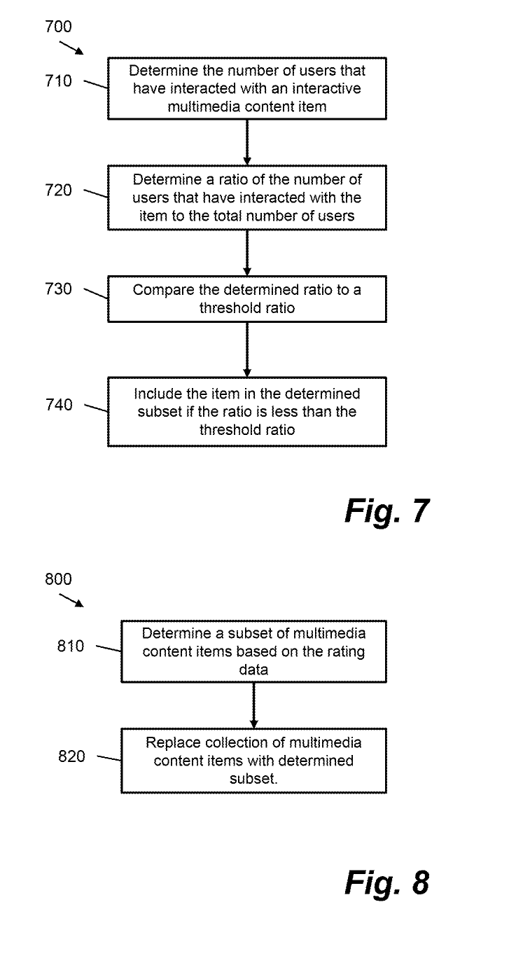

FIG. 7 shows a method 700, according to an example, of determining to include an interactive multimedia content item in the determined subset based on a comparison of a determined ratio to a threshold ratio for interactive multimedia content items. The method 700 shown in FIG. 7 may be used in conjunction with the apparatus shown in FIGS. 1 to 4 and the method shown in FIGS. 5 and 6 to keep interactive multimedia content items in a determined subset for which a proportion of users in a group of users accessing the interactive multimedia resource have not yet interacted with. At block 710 a number of users who have interacted with an interactive multimedia content item in a multimedia resource is determined. In an example of the method 700 being used in conjunction with the apparatus 100 shown in FIG. 1, this determination can be made by the interface which is arranged to acquire rating information. In this case the rating information provides an indication of whether a user has interacted with the interactive multimedia content item. In another example, a user may provide information indicating that they have interacted with an item to the interface. For example, if interacting with an item through an interface comprises downloading the item to a user's desktop PC, then the user may indicate, via the interface, that they have successfully completed downloading the item. The interface acquires the information directly from the user in this case. At block 720, a ratio of the number of users that have interacted with the item to the total number of users in a group of users accessing the multimedia resource is determined by, for example, rating module 150 in FIG. 1. At block 730 the determined ratio from the previous step is compared to a threshold ratio. This threshold ratio may be a user-defined value or a pre-set value determined by a third-party as in the case of a threshold ratio for users accessing the (interactive or non-interactive) content. Alternatively, the threshold may be a variable threshold which is adjusted depending on user preferences. According to one example of method 700, this step may be performed by a determination module such as determination module 160 shown in FIG. 1. At block 740, a multimedia content item is included in the determined subset if the determined ratio is found to be below the threshold ratio. As with the case of retaining multimedia content items which only a proportion of users have accessed, this step ensures that only those interactive items for which a significant proportion of users have interacted with can be left out of the determined subset. This step may be implemented by determination module 150 shown in FIG. 1.

FIG. 8 shows a method 800, according to an example of replacing a collection of multimedia content items in a multimedia resource with a subset of the content items. The method 800 shown in FIG. 8 may be used in conjunction with the apparatus shown in FIG. 3. At block 810 a subset of multimedia content items is determined based on rating data. The determination may be made by a determination module such as that shown in FIGS. 1 to 3. At block 820 the collection of multimedia content items is replaced with the determined subset of multimedia content items. The replacement of multimedia content items in a multimedia resource may be made by instructing a database such as database 350 shown in FIG. 3 to replace the stored multimedia content items with the determined subset 360. In another example of method 800, where multimedia content items are stored in a distributed fashion across a network, instructions to replace the collection of multimedia content items with the determined subset may be sent to nodes of the network storing content items.

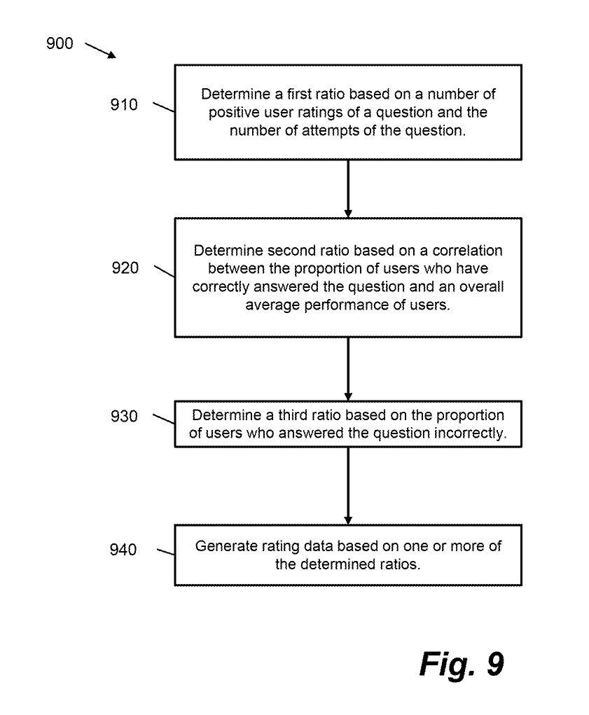

FIG. 9 shows a method, according to an example of generating rating data based on determined ratios associated to multimedia content. The method may be used in conjunction with an instantiation of the systems and apparatus described where the multimedia content items are examination questions relating to an educational resource. At block 910 a first ratio based on the number of positive user ratings a question has received and the number of attempts by users of the question is determined. In relation to the apparatus 200 shown in FIG. 2, a group of users may access questions 130A, 130B and 130C stored in a database 140 as shown in FIG. 1 and provide user ratings via a graphical user interface 230. Users attempt to provide solutions to the questions and rating data in the form of a user rating. A user may provide a rating, for example by providing a rating value as shown in FIG. 2. In this case a rating module 220 may deem a rating to be “positive” if the rating is above a threshold value (say, 5 or more on a rating scale of 1 to 10) for a question. Rating module 220 can then determine the total number of “positive” ratings of the question. In addition, rating module 220 can determine the number of users who have attempted the question and determine a ratio of the number of users providing positive ratings to the number of users who have attempted the question. At block 920 a second ratio based on a correlation between the proportion of users who have correctly answered the question and overall average performance of the users is determined. For example, if, for a first question, 60% of users who attempted the question correctly answer the question, and, for a second question, only 30% of users correctly answer the question, then, if the average user score was 50%, the first question would have a higher correlation with overall user performance than the second question. Alternatively, if the average overall user performance was 35% the second question would have a higher correlation with the overall student performance. Hence, this quantity provides an indication of the relative difficulty of a question in relation to other questions attempted by users. At block 930 a third ratio based on the proportion of users who have answered a question incorrectly is determined. This ratio can be determined by a rating module such as rating module 220 in FIG. 2. Finally at block 940, rating data is generated based on one or more of the ratios. According to an exemplary use of method 900, a rating module may calculate rating data using this method by, for example, determining one of these ratios or determining two or more of the ratios and combining the ratios additively to produce a score, per question, which reflects two or more properties of rating information.

Determining a subset of content of a multimedia resource in the manner described herein has an advantage of providing a system for users to control quality of a multimedia resource in a collaborative environment. Certain embodiments described herein allow users to submit their own multimedia content items for other users to access, interact with and rate. Thus the system provides a highly collaborative approach to refining and providing a multimedia resource to a large distributed group of users. Providing the infrastructure to rate content also allows for decentralization of multimedia content quality control. This reduces the need for providers to control quality through, for example, proprietary multimedia content, which it is believed many users would be dissuaded from accessing.

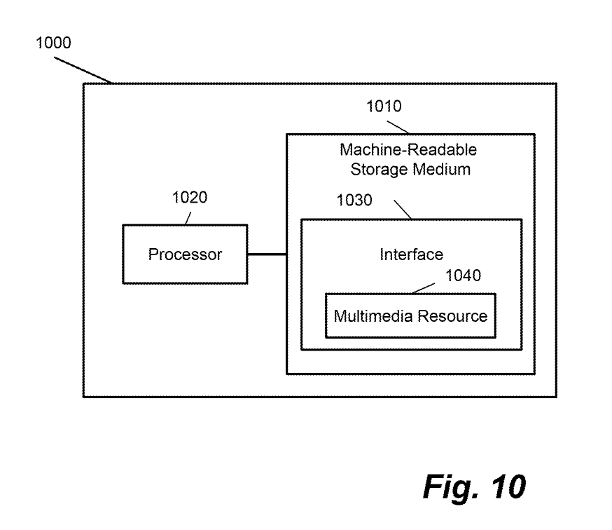

Certain methods and systems as described herein may be implemented by a processor that processes program code that is retrieved from a non-transitory storage medium. FIG. 10 shows an example 1000 of a device comprising a machine-readable storage medium 1010 coupled to a processor 1020. Machine-readable media 1010 can be any media that can contain, store, or maintain programs and data for use by or in connection with an instruction execution system. Machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc. In FIG. 10, the machine-readable storage medium comprises program code to effect an interface 1030 for accessing a multimedia resource 1040 as described in the foregoing examples herein.

Similarly, it should be understood that the interface 1030 may in practice be alternatively provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least an interface 1030 as described above, which are configurable so as to operate in accordance with the described examples. In this regard, the described examples may be implemented at least in part by computer program code stored in (non-transitory) memory and executable by the processor, or by hardware, or by a combination of tangibly stored code and hardware (and tangibly stored firmware).

The preceding description has been presented to illustrate and describe examples of the principles described. This description is not intended to be exhaustive or to limit these principles to any precise form disclosed. Many modifications and variations are possible in light of the above teaching.

What is claimed is:

1. An apparatus comprising:
an interface arranged to provide, to a group of one or more users, access to a stored multimedia resource comprising a collection of multimedia content items and to acquire rating information associated therewith;
a rating module arranged to generate and store rating data indicative of the rating information of at least some of the multimedia content items;
a determination module arranged to determine a subset of the collection of multimedia content items on the basis of at least the rating data.

2. The apparatus according to claim 1, wherein the rating information comprises at least one of:
user generated information;
computer-generated information relating to the multimedia content items;
for an accessed multimedia content item, a rating value selected from a set of two or more rating values by a user who has accessed the multimedia content item; or
an indication of the number of users who have accessed the multimedia content item.

3. The apparatus according to claim 2, wherein the rating module is arranged to determine, for a respective multimedia content item, a ratio of the number of users who have accessed the multimedia content item to a total number of users in the group.

4. The apparatus according to claim 1, wherein at least one multimedia content item of the collection is interactive.

5. The apparatus according to claim 4, wherein the rating module is arranged to determine, for a respective interactive multimedia content item, a ratio of a number of users who have interacted with the respective interactive multimedia content item to a total number of users in the group.

6. The apparatus according to claim 1, wherein the multimedia resource comprises one or more multimedia content items relating to an educational resource.

7. The apparatus according to claim 6, wherein the one or more multimedia content items comprise questions relating to the educational resource and wherein an interaction with interactive multimedia content comprises a user submitting solutions to the questions.

8. The apparatus according to claim 7, wherein the rating module is arranged to generate rating data according to at least one of:
a first determined ratio based on a number of positive user ratings of a respective question and a number of attempts of the respective question;
a second determined ratio based on a correlation between a proportion of users who answered the respective question correctly and an overall performance of users; or
a third determined ratio based on a proportion of users who answered the respective question incorrectly.

9. The apparatus according to claim 8, wherein the determination module is arranged to:
compare, for a first question and a second question, one or more of the first determined ratio, the second determined ratio and the third determined ratio; and
based on the result of the comparison, determine that one of the first question or the second question is in the subset.

10. The apparatus according to claim 1, wherein the determination module is arranged to replace the collection of multimedia content items with the subset of multimedia content items to form a new collection of multimedia content items.

11. A method comprising:
accessing a multimedia resource comprising a collection of multimedia content items;
acquiring rating information associated to the one or more multimedia content items from one or more users;
generating and storing rating data indicative of the rating information of at least some of the multimedia content items; and
determining a subset of the collection of multimedia content items on the basis of at least the rating data.

12. The method according to claim 11, wherein the rating information comprises at least one of:
user generated information;
computer-generated information relating to the multimedia content items;
for an accessed multimedia content item, a rating value selected from a set of two or more rating values by a user who has accessed the multimedia content item; or
an indication of the number of user who have accessed the multimedia content item.

13. The method according to claim 11, comprising:
determining, for a respective multimedia content item, a ratio of a number of users who have accessed the respective multimedia content item to a total number of users in the group.

14. The method according to claim 11, wherein at least one multimedia content item of the collection is interactive.

15. The method according to claim 14, comprising:
determining, for a respective interactive multimedia content item, a ratio of the number of users who have interacted with the item to a total number of users in the group.

16. The method according to claim 11, wherein the multimedia resource comprises one or more multimedia content items relating to an educational resource.

17. The method according to claim 16, wherein the one or more multimedia content items comprise questions relating to the educational resource and wherein an interaction with interactive multimedia content comprises a user submitting solutions to the questions.

18. The method according to claim 17, wherein the rating data is generated according to at least one of:
a first determined ratio based on a number of positive user ratings of a respective question and the a of attempts of the respective question;
a second determined ratio based on a correlation between a proportion of users who answered the respective question correctly and an overall performance of users; or
a third determined ratio based on a proportion of users who answered the respective question incorrectly.

19. The method according to claim 18, comprising:
comparing, for a first question and a second question, one or more of the first determined ratio, the second determined ratio and the third determined ratio; and
based on the result of the comparison, determining that one of the first question or the second question is in the subset.

20. A non-transitory computer-readable storage medium storing instructions that, when executed by one or more processors, cause the one or more processors to:
access a multimedia resource comprising a collection of multimedia content items;
acquire rating information associated to the one or more multimedia content items from one or more users;
generate and store rating data indicative of the rating information of at least some of the multimedia content items; and
determine a subset of the collection of multimedia content items on the basis of at least the rating data.
